(19) United States
(12) Patent Application Publication
(10) Pub. No.: US 2002/0017289 A1
(43) Pub. Date: Feb. 14, 2002

(54) Barbecue cooking device

(76) Inventors: Ian John Carr, Pooraka (AU); Christine Ann Carr, Pooraka (AU)

Correspondence Address: BIRCH STEWART KOLASCH & BIRCH, PO BOX 747, FALLS CHURCH, VA, 22040-0747, US

(21) Appl. No.: 09/885,936

(22) Filed: Jun. 22, 2001

(30) Foreign Application Priority Data
Jun. 22, 2000 (AU) PQ8273

(51) Int. Cl. A47J 37/00

(52) U.S. Cl. 126/25 R; 99/450; 99/448

(57) ABSTRACT

The invention relates to an improved barbecue cooking device. The barbecue cooking device has particular application for use with wood or charcoal fuels and enables the cooking platform to be raised and lowered towards the heat source.

### FIELD OF THE INVENTION

The present invention relates to a barbecue cooking device and more particularly to a barbecue cooking device which uses a wood or charcoal fuel.

### BACKGROUND OF THE INVENTION

Despite the increasing use of gas barbecues, wood and charcoal fuel barbecues remain popular. Charcoal is widely used as a fuel in barbecue kettles, whilst wood fires remain the common cooking medium for campers and the like.

One of the difficulties with using charcoal or wood as a fuel for barbecues is that it is difficult to control the heat to the cooking platform as the intensity of the heat source varies. This often leads to burning of the food being barbecued getting burnt. The present invention seeks to address this problem.

### SUMMARY OF THE INVENTION

According to a first aspect of the present invention there is provided a cooking device including a base plate, an upright arranged to be detachably connected to the baseplate and a cooking platform, said cooking platform being arranged to be detachably connected to the upright and further arranged so that it can be moved towards and away from the base plate.

Preferably the upright has a lower end and an upper end. The base plate is preferably arranged to be connected adjacent the lower end of the upright. The cooking platform is preferably arranged to be detachably connected adjacent to the upper end of the upright.

Preferably, the upper end of the upright is threaded and the cooking platform includes a bore with an internal mating thread. The cooking platform is preferably arranged to be moved towards and away from the base plate by rotating the cooking plate so that it drives down and up respectively along the thread of the upright.

In one embodiment of the invention, the lower end of the upright is threaded and is arranged to engage with a mating threaded bore formed in or on the base plate. The lower end of the upright being arranged to extend through the threaded bore so that a locking nut can be attached thereto and tightened against the underside of the base plate to prevent the base plate and upright from accidentally detaching.

The threaded bore in the base plate is preferably formed by attaching a nut or the like by welding to the base plate. The threaded bore in the cooking platform is preferably formed by attaching a nut or the like by welding to the cooking platform.

The base plate preferably includes a series of apertures to enable air to pass therethrough during cooking when the cooking device is positioned in a barbecue kettle.

The base plate is preferably made from a sheet of metal plate and is preferably circular.

The cooking platform is preferably made from a metal grill and is preferably circular. At least one handle is preferably provided on the cooking platform to facilitate removal of the cooking platform from the upright and rotation of the cooking platform.

The diameter of the cooking platform is preferably greater than the diameter of the base plate.

The bore in the base plate and the bore in the cooking platform are preferably located at their respective centres.

The upright is preferably threaded along its entire length so as to provide maximum possible variation in the height of the cooking platform above the base plate.

In another embodiment of the invention, the base plate includes a sleeve arranged to receive the lower end of the upright. The lower end of the upright and the sleeve being sized so that the upright is supported by the sleeve.

In another preferred arrangement, the base plate is sized so that it can be located within the bowl of a conventional barbecue kettle.

### BRIEF DESCRIPTION OF THE DRAWINGS

Embodiments of the invention will now be described, by way of example only, with reference to the accompanying drawings in which:

FIG. 1 is a perspective view of a cooking device in accordance with an embodiment of the invention.

FIG. 2 is a side view of the cooking device shown in FIG. 1.

FIG. 3 is a side view of a cooking device in accordance with a second embodiment of the invention.

FIG. 4 is a side view of the device shown in FIG. 1 when in use in a conventional barbecue kettle.

### DETAILED DESCRIPTION OF THE PREFERRED EMBODIMENTS

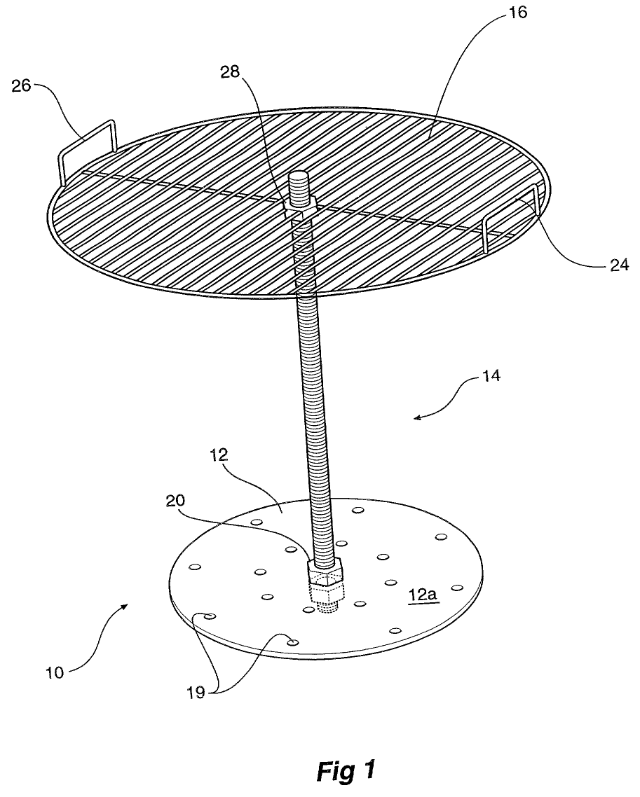

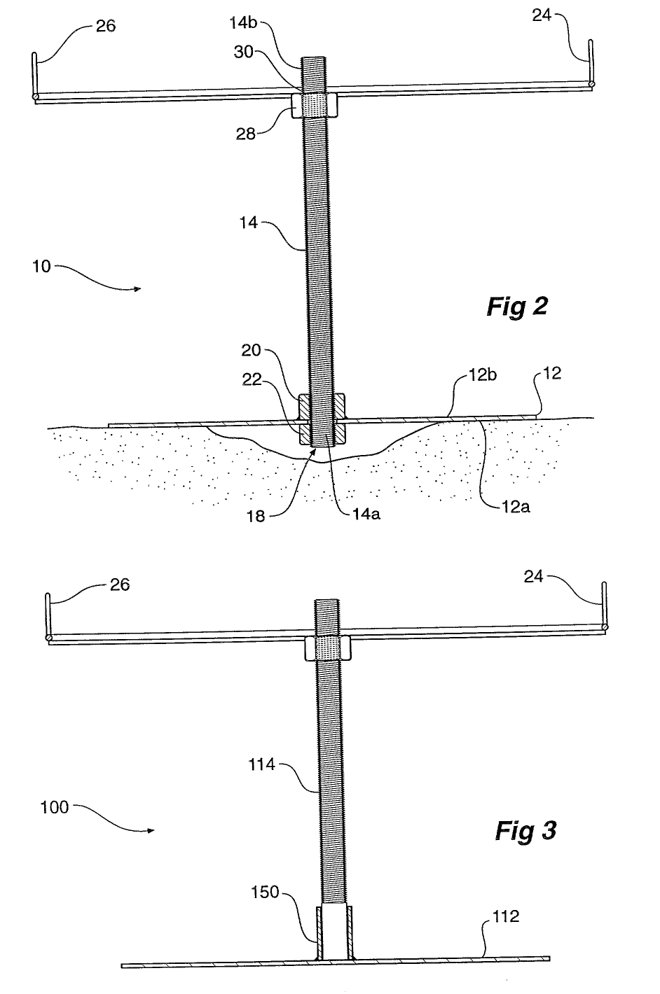

FIGS. 1 and 2 illustrate a cooking device or barbecue 10 including a base plate 12, an upright 14 and a cooking platform 16.

The base plate 12 is formed from a sheet of metal plate and is circular. The base plate 12 includes a central aperture 18 and a plurality of air flow apertures 19. The function of the air flow apertures 19 will be described subsequently. Attached coaxially about the central aperture 18 and welded to the base plate 12 is a nut 20.

The upright 14 is formed form a length of metal rod which includes an external thread which is sized to engage with the thread of the nut 20. The upright 14 has a lower end 14a and an upper end 14b. The lower end 14a is arranged to matingly engage with the thread on the nut 20 and to extend through the aperture 18 so that a locking nut 22 can be applied to the lower end 14a of the upright 14 and thereby lock the upright 14 to the underside 12a of the base plate 12.

The cooking platform 16 is circular in shape and is formed as a grill. The grill should be sized to prevent food falling through. The cooking platform 16 includes a pair of handles 24, 26 which facilitate removal of the cooking platform 16 from the upright 14 and rotation thereon. The cooking platform 16 may also include a peripheral rim or hoop to prevent food from inadvertently falling off the platform.

Located centrally of the cooking platform 16 is a threaded bore 28. As illustrated in FIG. 2, the threaded bore 28 is formed by welding a nut to the underside of the cooking platform 16 so that it is in coaxial alignment with an aperture 30 formed therein. Alternatively, the nut 28 could be integrally formed with the grill of the cooking platform 16. The thread of the nut 28 is sized so that it can matingly engage with the thread on the upright 14. This enables the upper end 14b of the upright 14 to be located within the bore 28 of the cooking platform 16. The cooking platform 16 can then be rotated about the upright 14 so that the cooking platform 16 can be driven along the length of the upright 14. This enables the cooking platform 16 to be easily moved towards and away from the base plate 12.

To use the barbecue 10, the upright 14 must first be attached to the base plate 12 using the locking nut 22. The cooking platform 16 can then be attached to the upright 14 by engaging the upper end 14b with the bore 28 and simply rotating the cooking platform 16.

After the barbecue 10 is assembled it should be placed on the ground and then the user should scrape the dirt under the base plate 12 and the locking nut 22 so that the base plate 12 sits flat on the ground. Typically a small depression will need to be formed in the ground into which the locking nut 22 can be positioned.

A fire can then be built on an upper surface 12b of the base plate 12.

The height of the cooking platform 16 above the base plate 12 can then be adjusted to suit the height of the flames or heat of the fire which has been established on the base plate 12. When the fire is first established it may be appropriate to maintain the cooking platform 16 towards the upper end 14b of the upright 14. However, once the fire has died down so that only coals or embers remain, the cooking platform 16 can be rotated down along the length of the upright 14 towards the base plate 12. Thus, it will be appreciated that the height of the cooking platform 16 above the base plate 12 can be readily adjusted to suit any cooking situation.

FIG. 3 illustrates an alternative embodiment of the barbecue 100. In accordance with this embodiment, the base plate 112 includes a centrally located sleeve 150, instead of the nut 20 as described in connection with the embodiment of FIG. 1. The sleeve 150 is sized so that it can receive and support the upright 114 in the desired orientation. The upright 114 does not extend through the base plate and thus no locking nut 22 is required.

It will be appreciated that the upright 114 in accordance with the embodiment of FIG. 3 need not be threaded at its lower end and that the cooking platform 116 is formed substantially the same as described in relation to the embodiment of FIG. 1.

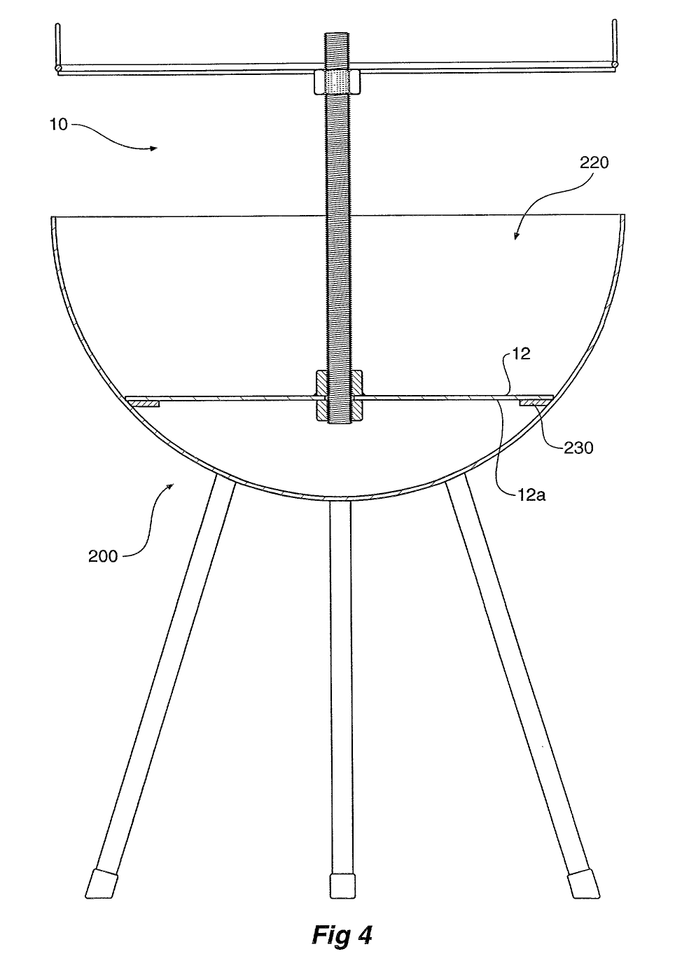

FIG. 4 illustrates the barbecue 10 shown in FIGS. 1 and 2 ready for use in a conventional barbecue kettle 200. The base plate 12 of the barbecue 10 is supported within the bowl 220 of the kettle 200 by resting the periphery of the underside 12a of the base plate 12 against the supports 230. The supports 230 would conventionally support the grill on which the kettle fuel would be located.

A fire can then be built on the upper surface 12b of the base plate 12. Air to fuel the fire on the base plate 12 is drawn from underneath the base plate 12 through the air flow apertures 19 formed therein

The described embodiments of the present invention provide a simple but effective mechanism by which the height of a cooking platform can be adjusted to suit the intensity of the heat source used to barbecue the food located on the cooking platform. The barbecues described herein can be readily assembled and disassembled and include the minimum of componentry. Accordingly, they can be easily disassembled when not required.

It is envisaged that barbecues in accordance with an embodiment of this invention could be sized so that when disassembled they can be stored within the wheel well of a vehicle. Alternatively, they could be stored within a case or other packaging so that they would not dirty or damage a vehicle after use and when being transported.

The embodiments have been described by way of example only and modifications are possible within the spirit and scope of the invention.

The claims defining the invention are as follows:

1. A cooking device including a base plate, an upright arranged to be detachably connected to the baseplate and a cooking platform, said cooking platform being arranged to be detachably connected to the upright and further arranged so that it can be moved towards and away from the base plate.

2. A cooking device according to claim 1 wherein the upright has a lower end and an upper end, the base plate is arranged to be detachably connected adjacent the lower end of the upright and the cooking platform is arranged to be detachably connected adjacent the upper end of the upright.

3. A cooking device according to claim 2 wherein the upper end of the upright is threaded and the cooking platform includes a bore with an internal mating thread.

4. A cooking device according to claim 2 or claim 3 wherein the lower end of the upright is threaded and is arranged to engage with a mating threaded bore formed in or on the base plate.

5. A cooking device according to claim 4 wherein the lower end of the upright is arranged to extend through the threaded bore so that a locking device can be attached thereto to prevent the base plate and upright from accidentally detaching.

6. A cooking device according to claim 4 wherein the threaded bore in the base plate is formed by a nut secured to the base plate.

7. A cooking device according to claim 3 wherein the threaded bore in the cooking platform is formed by a nut secured to the cooking platform.

8. A cooking device according to any one of the preceding claims further including at least one aperture formed in the base plate to enable air to pass therethrough.

9. A cooking device according to any one of the preceding claims wherein the base plate is made from a sheet of metal plate.

10. A cooking device according to any one of the preceding claims wherein the base plate and/or the cooking platform is circular.

11. A cooking device according to any one of the preceding claims wherein the cooking platform is made from a metal grill.

12. A cooking device according to any one of the preceding claims wherein at least one handle is provided on the cooking platform.

13. A cooking device according to claim 10 wherein the diameter of the cooking platform is greater than the diameter of the base plate.

14. A cooking device according to claim 4 wherein the bore in the base plate and the bore in the cooking platform are located at their respective centres.

15. A cooking device according to any one of the preceding claims wherein the base plate includes a means for spacing the base plate from the ground.

16. A cooking device according to claim 15 wherein the spacing means also serves to stabilise the device when it is located on a surface.

17. A cooking device according to any one of the preceding claims wherein the upright is threaded along its entire length.

18. A cooking device according to any one of claims 2, 3, and 7 to 13 wherein the base plate includes a sleeve arranged to receive the lower end of the upright.

19. A cooking device according to any one of the preceding claims wherein the base plate is sized so that it can be located within the bowl of a barbecue kettle.

20. A cooking device substantially as hereinbefore described with reference to the accompanying drawings.
